(19) United States
(12) Patent Application Publication
(10) Pub. No.: US 2013/0077898 A1
(43) Pub. Date: Mar. 28, 2013

(54) Pouch with Laser-Treated Straw Piercing Zone

(71) Applicants: Paul E. Doll, Madison, WI (US); Marie N. Evers, Stamford, CT (US)

(72) Inventors: Paul E. Doll, Madison, WI (US); Marie N. Evers, Stamford, CT (US)

(21) Appl. No.: 13/243,460

(22) Filed: Sep. 23, 2011

(51) Int. Cl. B31B 1/25; A47G 21/18; B31B 29/74; B32B 38/00; B31B 49/04

(52) U.S. Cl. 383/202; 493/212; 493/240; 53/492

(57) ABSTRACT

A method and apparatus for improved straw access to the interior of a pouch formed from a multi-ply laminate includes a laser-treated area that has improved characteristics for enabling a straw to pass through the multi-ply laminate to access the interior of the pouch. The laser treated area is more crystalline than adjacent areas of the multi-ply laminate that causes the multi-ply laminate to fracture. One such multi-ply laminate includes a sealant layer, a foil layer, and a PET layer.

### FIELD

This description relates to an easy open feature for a pouch, and specifically to a straw insertion easy open feature for a pouch.

### BACKGROUND

Flexible pouches are known in the art to provide a cost-effective storage container for liquids. These pouches can be formed from a web of flexible material and sealed to create an interior to receive a desired amount of liquid. Specifically, one example flexible material includes a multi-ply structure of an interior sealant layer, an intermediate foil layer, and an outer polyethylene (PET) layer with adhesive layers disposed therebetween. The sealant layer can be elastic and the PET layer can be strong, which can combine to cause difficulty in puncturing the film.

One common use for such pouches is to store consumable liquids. In order to access the consumable liquid sealed within the pouch interior, a user can puncture the flexible material with a straw. Puncturing the flexible material of the pouch, however, can be difficult when the flexible material is generally elastic. For example, with the multi-ply pouch, the sealant and PET layers can have elastic properties such that the plies stretch with pressure from the straw rather than fracture.

One method of overcoming this disadvantage can include cutting an opening through the flexible material. The opening can then be covered with a patch of material that seals the liquid within the pouch interior while also providing an easier opening path for the straw. This method, however, disadvantageously increases costs for creating the pouch, including material and formation costs.

Another method is described in U.S. Pat. No. 6,116,782 (“the '782 patent”). The '782 patent discloses a method for creating an opening system in a pouch having walls of a multi-layer laminate to be pierced by a straw. The opening system includes applying laser energy to a laminate having an inner polyethylene layer adhered to a metal foil to create an area of delamination between the polyethylene and the metal foil. The '782 patent adds that if the pouch includes an outer polyester film, then this is preferably removed prior to application of the laser energy.

### SUMMARY

A method of creating an easy open feature in a laminate for penetration of a straw therethrough is described herein. The laminate is suitable for subsequent creation of a pouch for storing a potable liquid beverage. A laser is applied to a first surface of a multi-ply laminate within a straw piercing zone, which corresponds to the interior surface of the subsequently formed pouch. The multi-ply laminate includes, from the first surface to a second surface thereof: a sealant film, a first adhesive layer, a foil, a second adhesive layer, and a barrier film. The laser passes through the sealant film and the first adhesive layer absorbs energy from the laser. The first adhesive layer at least partially vaporizes due to the energy absorbed from the laser, which creates an area of delamination in the first adhesive layer between the sealant film and the foil within the straw piercing zone. Heat is radiated outward from the absorbed energy and vaporizing of the first adhesive layer to the sealant and barrier film within the straw piercing zone. The sealant and barrier films cool to a structure with a higher degree of crystallinity within the straw piercing zone than adjacent portions of the respective films. The pouch can also be formed from a laminate with an EVOH film positioned intermediately between the sealant film and the foil with an associated third adhesive layer. The EVOH film absorbing laser energy that passes through the first adhesive layer and contributing to radiating heat throughout the straw piercing zone.

A pouch containing a liquid beverage having a straw piercing zone is also described herein. The pouch is formed from a multi-ply laminate the includes, from an interior surface of the pouch to an exterior surface of the pouch, a sealant film, a first adhesive layer, a foil, a second adhesive layer, and a PET film. The pouch includes seals extending between opposing portions of the multi-ply laminate that create a sealed pouch interior for receiving the liquid beverage therein. The laser-treated straw piercing zone in the multi-ply laminate is configured to provide relatively easier straw penetration therethrough than an un-laser-treated portion of the multi-ply laminate. The straw piercing zone includes a delaminated portion of the first adhesive layer and at least partially crystallized portions of the sealant and PET films having a structure with a higher degree of crystallinity than adjacent portions thereof respectively. The pouch can also be formed from a laminate with an EVOH film positioned intermediately between the sealant film and the foil with an associated third adhesive layer.

A method of opening a pouch, such as the pouch described above, having a potable beverage in a sealed interior thereof is also described herein. An end portion of a straw is contacted to a pouch having walls of multi-ply laminate constructed as described above. The end portion of the straw is pushed through a laser-treated straw piercing zone of the PET film that has a structure with a higher degree of crystallinity than adjacent portions thereof. The end portion of the straw is then pushed through the foil. After the foil, the end of the straw is then pushed through a laser-created area of delamination in the first adhesive layer between the foil and the sealant film. The end portion of the straw in then pushed through the laser-treated straw piercing zone of the sealant film that has a structure with a higher degree of crystallinity than adjacent portions thereof to thereby access the potable beverage in the sealed interior of the pouch with the straw.

### BRIEF DESCRIPTION OF THE DRAWINGS

FIG. 1 is a perspective view of a pouch having a straw piercing zone with a straw aligned to puncture the pouch through the straw piercing zone;

FIG. 2 is cross-section view of one embodiment of the straw piercing zone of FIG. 1 showing a sealant film, a first adhesive layer, a foil, a second adhesive layer, and a PET film with a laser being applied to the sealant film within the straw piercing zone;

FIG. 3 is a cross-section view of the embodiment of the straw piercing zone of FIG. 2 showing an area of delamination of the first adhesive layer and the sealant and PET films being at least partially crystallized;

FIG. 4 is a cross-section view of the embodiment of the straw piercing zone of FIG. 3 showing a straw penetrating through the straw piercing zone;

FIG. 5 is a cross-section view of a second embodiment of the straw piercing zone of FIG. 1 showing a sealant layer, an adhesive layer, an EVOH layer, an adhesive layer; a foil layer, an adhesive layer, and a PET layer with a laser being applied to the sealant layer within the straw piercing zone;

FIG. 6 is a cross-section view of the embodiment of the straw piercing zone of FIG. 5 showing an area of delamination of the first adhesive layer and the sealant and PET films being at least partially crystallized;

FIG. 7 is a sectional rear plan view of the sealant layer of the pouch of FIG. 1 showing a spiral laser application pattern on the straw piercing zone of an interior surface of the multi-ply laminate;

FIG. 8 is a sectional rear plan view of the sealant layer of the pouch of FIG. 1 showing a vertically elongated spiral laser application pattern on the straw piercing zone of an interior surface of the multi-ply laminate;

FIG. 9 is a sectional rear plan view of the sealant layer of the pouch of FIG. 1 showing a stacked “V” laser application pattern on the straw piercing zone of an interior surface of the multi-ply laminate;

FIG. 10 is a sectional rear plan view of the sealant layer of the pouch of FIG. 1 showing a cross-hatch laser application pattern on the straw piercing zone of an interior surface of the multi-ply laminate;

FIG. 11 is a sectional rear plan view of the sealant layer of the pouch of FIG. 1 showing an “X” laser application pattern on the straw piercing zone of an interior surface of the multi-ply laminate;

FIG. 12 is a sectional rear plan view of the sealant layer of the pouch of FIG. 1 showing an overlapping “X” laser application pattern on the straw piercing zone of an interior surface of the multi-ply laminate;

FIG. 13 is a sectional rear plan view of the sealant layer of the pouch of FIG. 1 showing a “V” laser application pattern on the straw piercing zone of an interior surface of the multi-ply laminate;

FIG. 14 is a sectional front plan view of a cross-hatch score pattern on an exterior surface of the multi-ply laminate; and

FIG. 15 is a diagrammatic view of a pouch formation and laser application assembly.

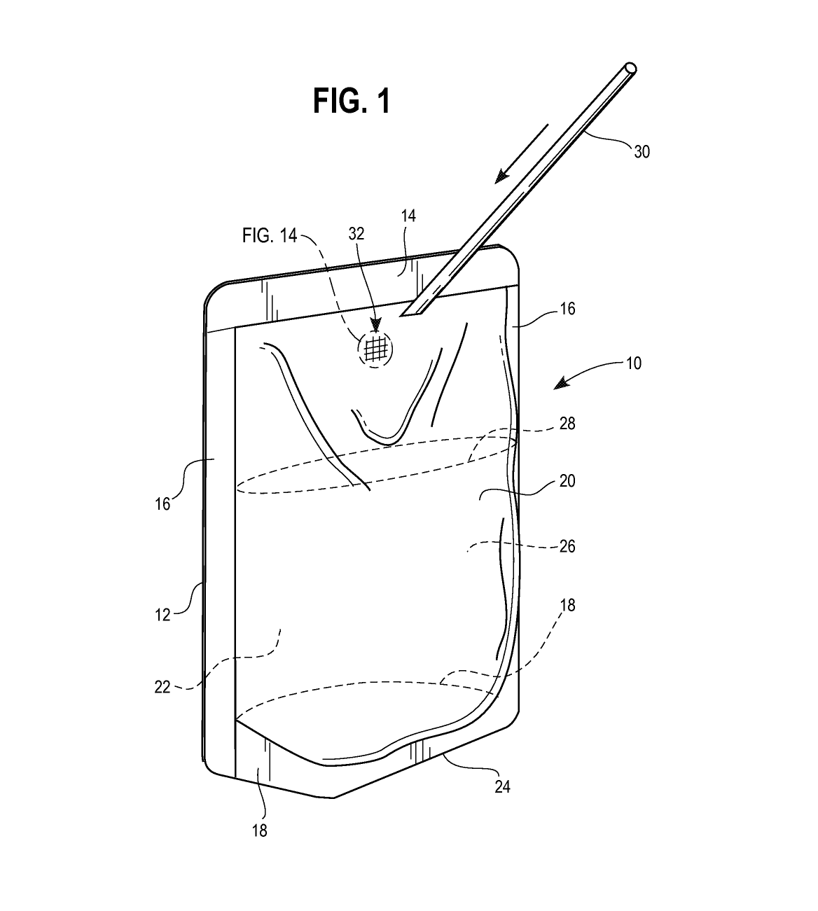

### DETAILED DESCRIPTION

A method and apparatus for improved straw access to the interior of a pouch is described herein. The pouch formed from a multi-ply laminate includes a laser-treated area that has improved characteristics for enabling a straw to pass through the multi-ply laminate to access the interior of the pouch. Specifically, the laser treated area is more crystalline than adjacent areas of the multi-ply laminate, which are more elastic. A crystalline structure causes the multi-ply laminate to fracture rather than stretch or distort. So configured, the force required to pierce the laser treated area is less than an untreated laminate.

One such multi-ply laminate includes a sealant layer, a foil layer, and a PET layer. To achieve the straw piercing zone, a laser is applied to the sealant layer in the desired area for straw piercing with the multi-ply laminate intact. The laser passes through the sealant layer to be absorbed by the adhesive layer between the sealant layer and the foil layer. The energy of the laser causes the adhesive to rapidly heat and vaporize within the area of laser application. This process with the adhesive layer radiates heat outward to heat the sealant and PET layers, which are then allowed to cool. The heating and cooling of the sealant and PET layers creates a more crystalline structure than adjacent areas of the sealant and PET layers. Without the PET layer intact during the laser application, heat could be lost through the foil layer causing the sealant layer to be relatively less crystalline as a result. Instead, the PET layer creates a more efficient insulation of the energy absorbed by the adhesive layer and thereby causes the sealant layer to be relatively more crystalline, as well as becoming more crystalline itself. After the laser has vaporized the adhesive layer between the sealant and the foil layers, a second laser application to the PET layer can score or remove portions thereof for further weakening the PET layer for piercing by a straw.

Another such multi-ply laminate includes an ethylene vinyl alcohol (EVOH) layer between the sealant and foil layers. The EVOH layer can absorb laser energy more efficiently than the adhesive, which results in less laser energy lost during application of the laser, higher temperatures of the sealant and PET layers, and therefore relatively more crystalline structure than with the adhesive layer alone.

Turning now to the figures, a flexible pouch 10 is formed from a multi-ply laminate 12. In the illustrated form, the pouch 10 includes a lateral top seal 14, side seals 16 extending downwardly from ends of the top seal 14, and bottom seals 18 extending between the side seals 16 so that the pouch 10 has opposing front and rear walls 20, 22 and a base 24 extending therebetween. So configured, the pouch 10 has a sealed interior 26 for storage of, for example, a potable beverage 28. As discussed above, a common method for consuming such a beverage 28 is piercing one of the walls 20, 22 with a straw 30 to access the beverage 28. In order to facilitate piercing the wall, a straw piercing zone 32 is provided on the front wall 20 that is configured to allow the straw 30 to pass more easily therethrough than adjacent portions of the front wall 20.

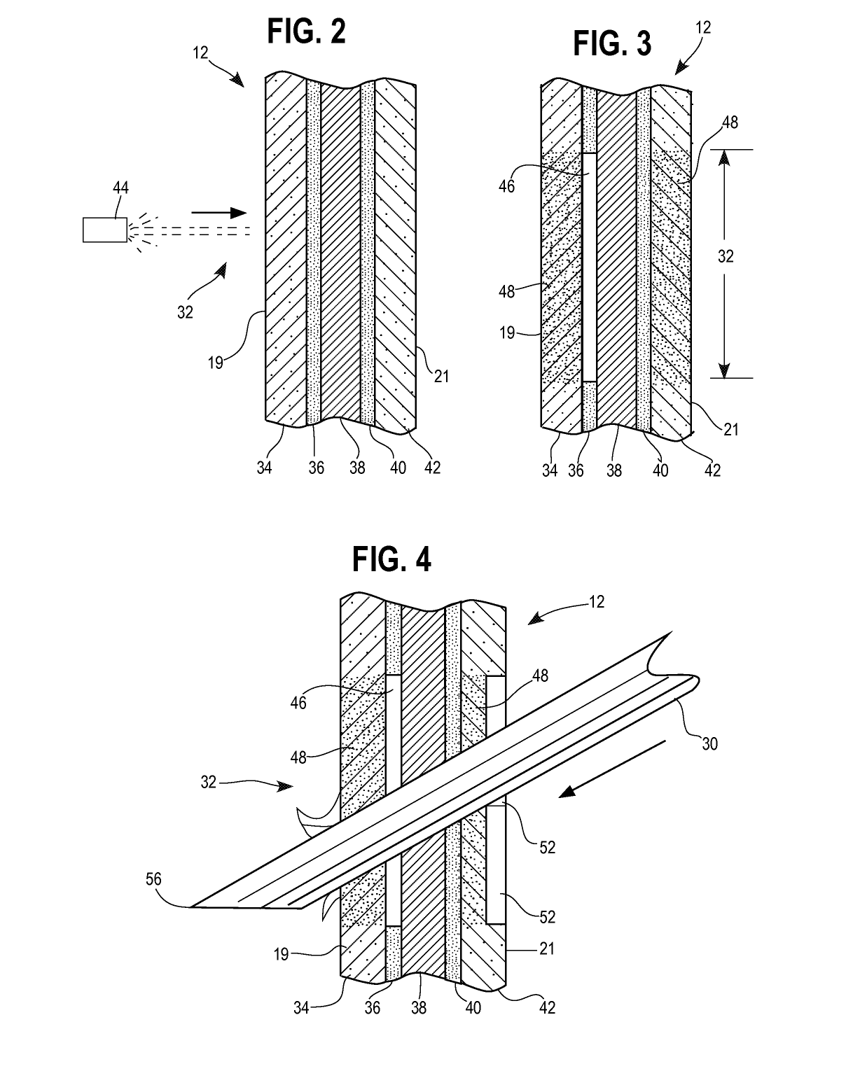

A cross-section of one example multi-ply laminate 12 is shown in FIG. 2. The multi-ply laminate 12 of this form includes, from an interior surface 19 to an outer surface 21 thereof, a sealant film 34, such as a polyethylene (PE) film, a first adhesive layer 36, a foil 38, such as aluminum foil, a second adhesive layer 40, and a barrier film 42, such as a PET film. FIG. 2 shows the plies in an exaggerated form for the sake of clarity. In one form, the multi-ply laminate 12 includes (from the interior surface to the exterior surface): 350 ga of PE film, 35 ga of Aluminum Foil, and 48 ga of PET film. The laminate 60 can also include ink or the like for display purposes. A preferred laminate, as described herein, can be supplied from Bemis Company, Inc.

With such a configuration, the straw piercing zone 32 can be laser-treated to have a higher crystallinity than adjacent areas of the pouch 10 and is therefore more susceptible to fracturing in this area rather than stretching with relatively more elastic portions of the pouch 10. For example, a laminate constructed as shown in FIG. 2 can require a piercing force of about 4.5 lbf to pierce a straw therethrough, while a laser treated laminate, as described herein, can require a piercing force of about 1.1 lbf. To test the piercing force of both the untreated and the treated laminate can be performed as follows. A straw is clamped in a force gauge about 0.5 to 1 inch from the end thereof. The laminate to be tested is then clamped on two sides thereof. Finally, the straw is pressed against the laminate until the laminate is pierced. The maximum force required to pierce the laminate is recorded.

Preferably, the sealant film 34 is at least partially invisible to the laser energy. For example, a CO₂ laser passes through a PE film because a PE film does not efficiently absorb energy on the wavelength of the CO₂ laser. As such, a laser 44 applied on the interior surface 19 of the multi-ply film 12 passes through the sealant film 34 to impact the first adhesive layer 36. The adhesive 36 absorbs a majority of the energy of the laser 44, which causes the adhesive 36 to vaporize in the area of laser application. The adhesive 36 absorbing and being vaporized by the laser 44 radiates heat across all the plies of the multi-ply laminate 12. Accordingly, the sealant and PET films 34, 42 are heated and allowed to cool. This heating and cooling process alters the structure of the sealant and PET films 34, 42 so that they are relatively more crystalline than before the laser treatment process. This is illustrated in FIG. 3 with an area of delamination 46 in the first adhesive layer 36 and altered, more crystalline structure 48 in the sealant and PET films 34, 42. Specifically, the sealant film 34 is elastic prior to the laser treatment and stretches when impacted by a straw, which makes it difficult to easily pierce, as shown in FIG. 4. With laser treatment, however, the sealant film 34 is relatively more brittle and fractures when impacted by a straw, which provides a significantly easier path for accessing the interior 26 with the straw 30.

One example laser is a LasX 100 watt laser, which can be utilized to treat the laminate 12 in the straw piercing zone 32 running the laminate through at about 2000 mm/sec. A CO₂ laser can operate at a wavelength of about 10 μm for transverse electrical discharge or 9 μm for longitudinal electrical discharge. The laser can be spaced from the laminate about 16 inches or more for a large field of view, but can be applied closer if desired. The specific optics configuration of the laser will determine the optimal distance.

Unlike U.S. Pat. No. 6,116,782 (“the '782 patent”), discussed in the background, the PET film 42 is left intact during the heating and cooling process described above. The '782 patent describes removing a portion of the polyester film at an area intended to be pierced by a straw. Without the polyester film, heat can be lost through the foil and out through the opening provided by the removed portion of the polyester film. Specifically, removing a portion of the polyester film allows heat generated by the application of the laser to dissipate relatively quickly, limiting the amount of crystallization created by the laser energy. Leaving the PET film 42 intact, however, advantageously creates a better thermal transfer from the heat generated by the vaporizing of the first adhesive layer 36 to the sealant and PET films 36, 42. As such, a laser application with similar characteristics causes the sealant film 36 be relatively more crystalline than would be created by the '782 patent. For example, treating a multi-ply laminate as described within respect to FIG. 2 with the method described in the '782 patent can achieve a piercing force of about 2.5 lbf, while with leaving the PET film intact, the laser treated multi-ply film 12 can have a piercing force of about 1.1 lbf, which can be tested as described above.

A cross-section of a second 60 example multi-ply laminate 12 is shown in FIG. 6. The multi-ply laminate 60 of this form includes, in addition to the layers of the previous example, an EVOH film 62 and an associated third adhesive layer 64. Accordingly, in this form, the multi-ply laminate 12 includes, from an interior surface 66 to an outer surface 68, the sealant film 34, the first adhesive layer 36, the EVOH film 62, the third adhesive layer 64, the foil 38, the second adhesive layer 40, and the PET film 42.

While the multi-ply laminate 60 of this form can increase costs of the pouch 10 as a result of the EVOH film 62 and the extra adhesive layer 64, the EVOH film 62 can increase laser absorption efficiency over the first adhesive layer 36 and the foil 38 layers in the previous multi-ply laminate 12. The EVOH film 62 is preferably laser receptive, while the foil 38 reflects the laser 44, so laser energy that passes through the first adhesive layer 36 and impacts the foil 38 reflects back toward the sealant film and can cause constructive and destructive interference. Radiant heating of the sealant film 34 is important because it spreads the heat over the desired area rather than undesirable focused heating. As with applying a laser with too much energy or crossing laser application paths discussed above, reflected laser energy can also cause holes in the sealant film 34 that can disadvantageously allow the beverage 28 to contact the foil 38. The addition of the EVOH film 62, however, advantageously can absorb any laser energy that passes through the first adhesive layer 36, which can add to the radiant heat permeating throughout the straw piercing zone 32 and substantially prevent reflected laser energy. So configured, after application of the laser 44 to the interior surface 66 of this multi-ply film 60, the sealant and PET films 34, 42 have the desired crystalline structure 48 in the straw piercing zone 32 and the first adhesive layer 36 includes the area of delamination 46 in the straw piercing zone 32, as shown in FIG. 6. As discussed above, an EVOH film can be relatively easily pierced by a straw, so the addition of the EVOH film 62 in the penetration path of the straw 30 in this multi-ply laminate 60 does not outweigh the benefit provided by the EVOH film 62 during laser treatment.

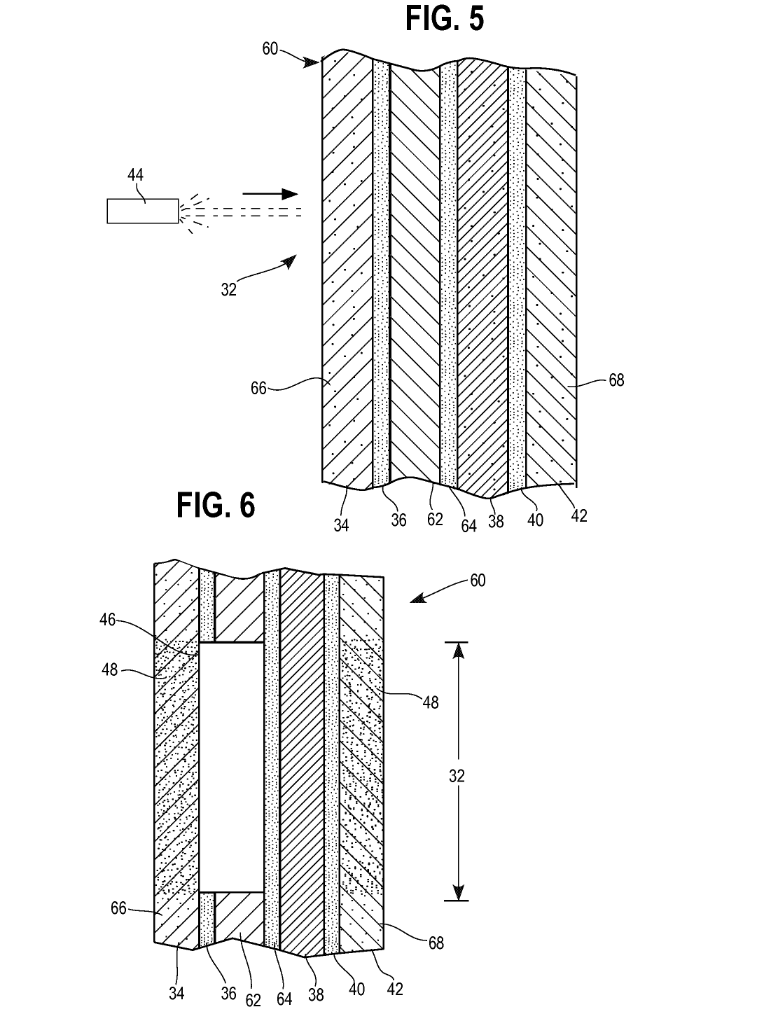

FIG. 5 shows the plies in an exaggerated form for the sake of clarity. In one form, the multi-ply laminate 60 includes (from the interior surface to the exterior surface): 350 ga of PE film, 0.5 mil of EVOH film, 35 ga of Aluminum Foil, and 48 ga of PET film. The laminate 60 can also include ink or the like for display purposes.

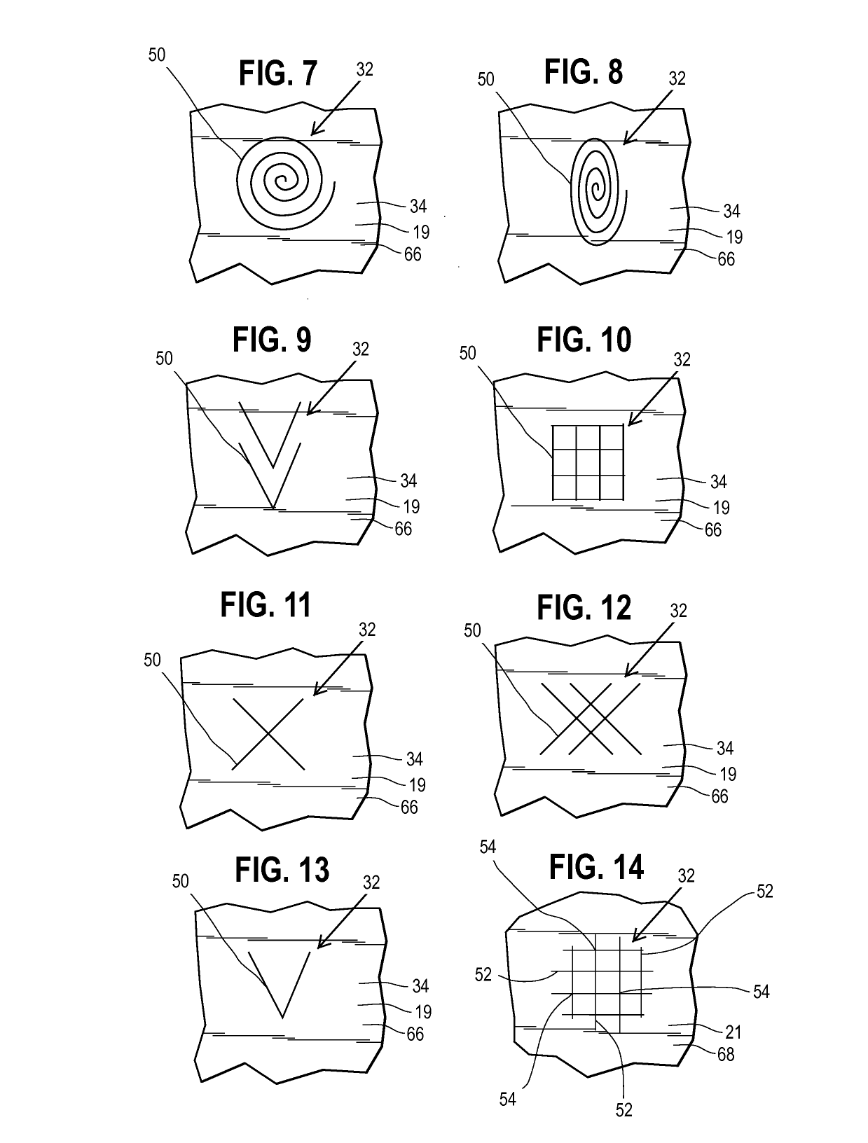

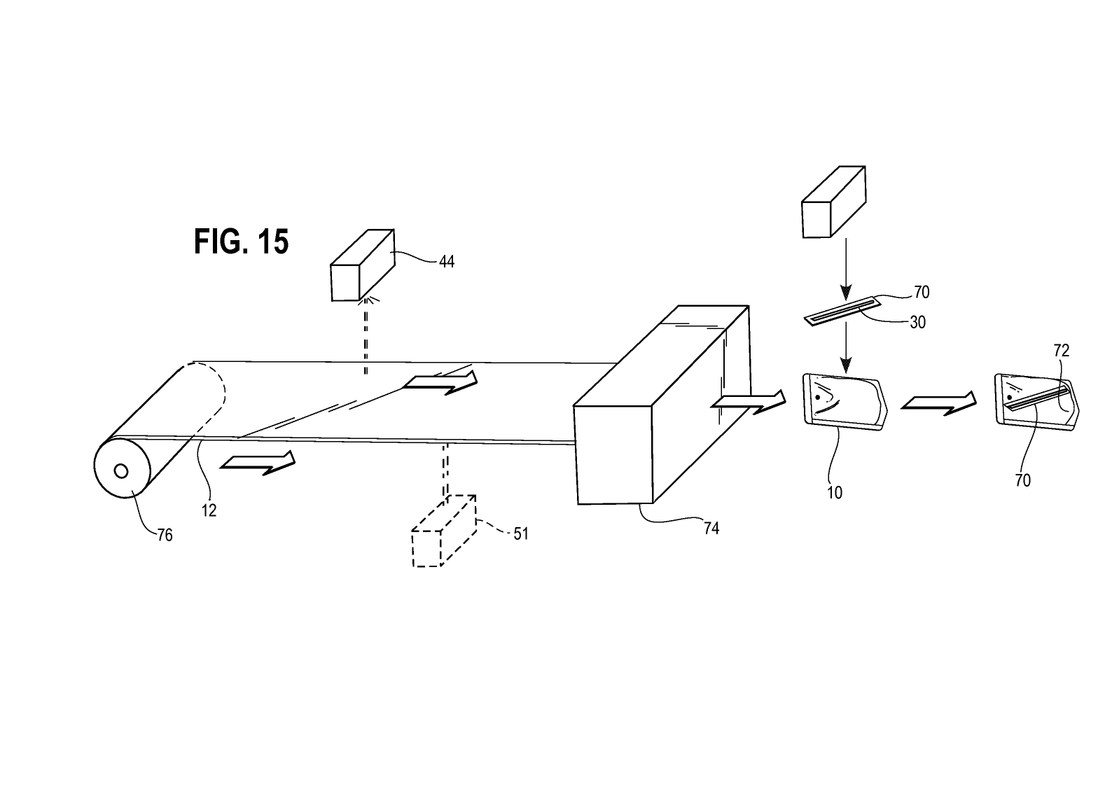

Referring now to FIG. 7, the interior surface 19 of the multi-ply laminate 12 is treated with the laser 44 in a shape 50 configured to produce a desired shape of the straw piercing zone 32. Preferably, the shape 50 is a spiral pattern as shown in FIG. 7 or an elongated spiral pattern as shown in FIG. 8 to produce a generally circular straw piercing zone 32. Other suitable patterns are shown in FIGS. 9-13, which include a “V” shape, for example being 4 mm tall, two stacked “V” shapes, a grid of lines, for example, 2×2, 3×3, 4×4, or the like, such as spaced about 0.5 mm apart, an “X” shape, for example being 4 mm tall, and two “X” shapes overlapping. Over application of the laser 44 to the sealant film 34 can disadvantageously create pin-holes or larger holes which can disadvantageously expose the foil 38 to the beverage 28.

After the laser 44 has been applied to the sealant film 34 side of the multi-ply laminate 12, which will be the interior surface 19 of the pouch 10, and the sealant and PET films 34, 42 at least partially crystallized, the PET film 42 can be scored or have one or more portions thereof removed to further weaken the PET film 42 within the straw piercing zone 32. This can be achieved with mechanical means, such as a die, or the like, or a laser, either utilizing the laser 44 used above or a second laser 51.

For example, by one approach as shown in FIG. 14, the PET film 42 can be scored within the straw piercing zone 32 with at least two intersecting score lines 52, and preferably a cross-hatch pattern, to provide one or more catch points 54 for a tip or other end portion 56 of the straw 30. Once the straw tip 56 catches on one of the catch points 54, the straw 30 passes easily through the PET film 42 with the combination of the score line 52 and the brittle structure 48 of the laser-treated PET film 42 in the straw piercing zone 32. Alternatively, one of the patterns shown in FIGS. 7-13, or the like, can be utilized. By another approach, the PET film 42 can have a portion removed.

If desired, the straw 30 can be sealed within a package 70 and attached to an exterior 72 of the pouch 10 for convenience of the user. The package 70 can be created by any suitable method and machinery, including, for example, vertical or horizontal form, fill, and seal machinery. As shown in FIG. 9, the multi-ply laminate 12, 60 described herein can advantageously be run continuously through pouch forming machinery 74 capable of manipulating the laminate after application of the first and optionally the second lasers 44, 51, such as off a roll 76 of laminate, forming the top, side, and bottom seals 14, 16, 18, filling the pouch 10 with the potable beverage 28, and attaching the straw package 70 with the straw 30 sealed therein to the exterior 72 of the pouch 10, using any suitable mechanism, including, for example, a suitable adhesive.

The drawings and the foregoing descriptions are not intended to represent the only forms of the package in regards to the details of construction. Changes in form and in proportion of parts, as well as the substitution of equivalents, are contemplated as circumstances may suggest or render expedient.

1. A method of creating an easy open feature for insertion of a straw in a laminate usable for creation of pouch for storing a beverage, the method comprising:
applying a laser to a first surface of multi-ply laminate within a straw piercing zone, the laminate comprising, from the first surface to a second surface thereof: a sealant film, a first adhesive layer, a foil, a second adhesive layer, and a barrier film;
absorbing energy from the laser with the first adhesive layer;
at least partially vaporizing and creating an area of delamination in the first adhesive layer between the sealant film and the foil within the straw piercing zone;
radiating heat to the sealant and barrier films within the straw piercing zone due to the vaporizing of the first adhesive layer; and
cooling of the sealant and barrier films to a structure with a higher degree of crystallinity within the straw piercing zone than adjacent portions of the respective films.

2. The method of claim 1 wherein applying the laser to the multi-ply film comprises applying the laser to the multi-ply film in a spiral configuration.

3. The method of claim 1 further comprising forming the multi-ply film into the pouch.

4. The method of claim 1 further comprising weakening the barrier film using a laser to ease piercing by a straw after the step of applying the laser to the interior surface.

5. The method of claim 4 wherein weakening the barrier film comprises scoring the barrier film with at least two intersecting score lines within the straw piercing zone.

6. The method of claim 5 wherein weakening the barrier film comprises scoring the barrier film with a cross hatch pattern within the straw piercing zone.

7. The method of claim 4 wherein weakening the barrier film comprises removing a portion of the barrier film within the straw piercing zone.

8. The method of claim 1 wherein the laminate comprises, from the interior surface to the exterior surface thereof: a sealant film, a first adhesive layer, an EVOH film, a third adhesive layer, a foil, a second adhesive layer, and a barrier film; and applying the laser to the interior surface of the multi-ply laminate further comprises the EVOH film absorbing laser energy passing through the first adhesive layer and radiating heat to the sealant and barrier films.

9. The method of claim 1 further comprising forming the laminate into a pouch with the first surface facing a sealed interior of the pouch and the second surface facing an exterior of the pouch.

10. The method of claim 9 wherein the pouch stores a potable beverage in the sealed interior thereof accessible by a straw through the straw piercing zone.

11. A pouch containing a liquid beverage having a straw piercing zone, the pouch comprising:
a multi-ply laminate comprising, from an interior surface to an exterior surface:
a sealant film;
a first adhesive layer;
a foil;
a second adhesive layer; and
a PET film;
seals extending between opposing portions of the multi-ply laminate creating a sealed pouch interior; and
a laser-treated straw piercing zone of the multi-ply laminate configured to provide relatively easier straw penetration therethrough than an un-laser-treated portion of the multi-ply laminate, the straw piercing zone comprising:
a delaminated portion of the first adhesive layer; and
at least partially crystallized portions of the sealant and PET films having a structure with a higher degree of crystallinity than adjacent portions thereof respectively.

12. The pouch of claim 11 wherein the multi-ply laminate further comprises an EVOH film and a third adhesive layer between the first adhesive layer and the foil.

13. The pouch of claim 11 wherein the PET film within the straw piercing zone includes a laser scored cross-hatch pattern.

14. The pouch of claim 11 further comprising a potable beverage within the sealed pouch interior.

15. The pouch of claim 14 further comprising a sealed package and a straw within the sealed package, and wherein the sealed package with the straw sealed therein is attached to the exterior surface of the multi-ply laminate.

16. A method of opening a pouch having a potable beverage in a sealed interior thereof, the method comprising:
contacting an end portion of a straw to a pouch having walls of multi-ply laminate, the multi-ply laminate comprising an interior sealant film, an intermediate foil, and an outer PET film with a first layer of adhesive between the sealant film and foil and a second layer of adhesive between the foil and PET film;
pushing the end portion of the straw through a laser-treated straw piercing zone of the PET film having a structure with a higher degree of crystallinity than adjacent portions thereof;
pushing the end portion of the straw through the foil;
pushing the end portion of the straw through a laser-created area of delamination in the first adhesive layer between the foil and sealant film; and
pushing the end portion of the straw through the laser-treated straw piercing zone of the sealant film having a structure with a higher degree of crystallinity than adjacent portions thereof to thereby access the potable beverage in the sealed interior of the pouch with the straw.

17. The method of claim 16 wherein pushing the end portion of the straw through the laser-treated straw piercing zone of the PET film includes orienting the end portion of the straw within the straw piercing zone by catching the end portion of the straw on an intersection of score lines in the PET film.
